(19) United States
(12) Patent Application Publication
(10) Pub. No.: US 2024/0253165 A1
(43) Pub. Date: Aug. 1, 2024

(54) GUARDING SYSTEMS AND METHODS FOR HANDHELD LASER WELDING

(71) Applicant: Illinois Tool Works Inc., Glenview, IL (US)

(72) Inventors: Shuang Liu, Appleton, WI (US); Andrew Pfaller, Hilbert, WI (US); Todd E. Holverson, Appleton, WI (US); Steven B. Massey, JR., Appleton, WI (US); Joseph C. Schneider, Greenville, WI (US); Bruce Patrick Albrecht, Neenah, WI (US); William R. Giese, Monee, IL (US)

(21) Appl. No.: 18/427,237

(22) Filed: Jan. 30, 2024

Related U.S. Application Data
(60) Provisional application No. 63/482,551, filed on Jan. 31, 2023.

(51) Int. Cl. B23K 26/70; B23K 26/00; B23K 26/03; B23K 26/21

(52) U.S. Cl. CPC B23K 26/70; B23K 26/0096; B23K 26/032; B23K 26/21

(57) ABSTRACT

Systems and methods for laser welding are disclosed. A laser welding system includes a manually operated laser welding torch to direct laser power to a workpiece to generate a puddle during a laser welding operation. The welding system includes a controller to regulate activation and regulation of the laser power based on user inputs, sensor inputs, and/or synergic control of a laser power source.

### CROSS REFERENCE TO RELATED APPLICATIONS

This application is a Non-Provisional Patent Application claiming priority to U.S. Provisional Patent Application No. 63/482,551 entitled “Systems And Methods For Laser Welding And Laser Welding Equipment” filed Jan. 31, 2023, and U.S. Provisional Patent Application No. 63/482,553 entitled “Systems And Methods For Laser Welding And Laser Welding Equipment” filed Jan. 31, 2023, both of which are herein incorporated by reference in their entirety.

### BACKGROUND

Welding is a process that has historically been a cost effective joining method. Welding is, at its core, a way of bonding two pieces of parent material. Laser welding is a welding technique used to join multiple pieces of metal through the use of a laser. The laser beam provides a concentrated heat source, enabling a precise control of the heat input and high welding speed, creating a weld with low heat input, and a small heat affected zone. In various applications, filler metal may be needed for different purposes such as filling a gap between workpieces, reinforcing the joint, overlaying a substrate surface, building up an object, or acting as a buffering medium.

Conventional laser-based welding tools can create challenges for new users, especially for manually operated laser welders. Even welders with long experience with arc-related welding systems may be unfamiliar with the peculiarities of a laser welding system, including how to achieve a quality weld bead and incorporate laser protection features. Thus, systems and/or methods that facilitate and stabilize welding from laser based welding systems with laser protection features is desirable.

### SUMMARY

This disclosure relates generally to laser welding systems, methods, and apparatuses. More particularly, this disclosure relates to manually operated laser welding systems and torches, which may employ a continuously fed electrode wire for use in laser welding processes, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example laser type welding system, in accordance with aspects of this disclosure.

FIG. 2 illustrates another example laser type welding system, in accordance with aspects of this disclosure.

FIG. 3 illustrates an example laser welding method employing a handheld laser welding torch, in accordance with aspects of this disclosure.

FIG. 4 illustrates another example laser welding method employing a handheld laser welding torch, in accordance with aspects of this disclosure.

The figures are not necessarily to scale. Wherever appropriate, similar or identical reference numerals are used to refer to similar or identical components.

### DETAILED DESCRIPTION

Disclosed example systems and methods for laser welding are provided. In particular, disclosed example laser welding systems include a manually operated laser welding torch to direct laser power to a workpiece to generate a puddle during a laser welding operation. The welding system includes a controller to regulate activation and regulation of the laser power based on user inputs, sensor inputs, and/or synergic control of a laser power source.

As used herein, the word “exemplary” means serving as an example, instance, or illustration. The examples described herein are not limiting, but rather are exemplary only. It should be understood that the described examples are not necessarily to be construed as preferred or advantageous over other examples. Moreover, the term “examples” does not require that all examples of the disclosure include the discussed feature, advantage, or mode of operation.

As used herein, a wire-fed welding-type system refers to a system capable of performing welding (e.g., gas metal arc welding (GMAW), gas tungsten arc welding (GTAW), etc.), laser beam welding (LBW—the process by which materials are fused together by laser light from a laser source), brazing, cladding, hardfacing, cleaning, ablating, and/or other processes, in which a filler metal is provided by a wire that is fed to a work location, such as an arc or weld puddle.

As used herein, the term “welding-type operation” includes a welding operation employing a laser welding systems using laser energy, operable to fuse, bind, clean and ablate, and/or cut one or more materials and/or layers of materials.

As used herein, a welding-type power source refers to any device capable of, when power is applied thereto, supplying welding, cladding, plasma cutting, induction heating, laser (including laser welding and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

For the purpose of promoting an understanding of the principles of the claimed technology and presenting its currently understood best mode of operation, reference will be now made to the examples illustrated in the drawings, and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

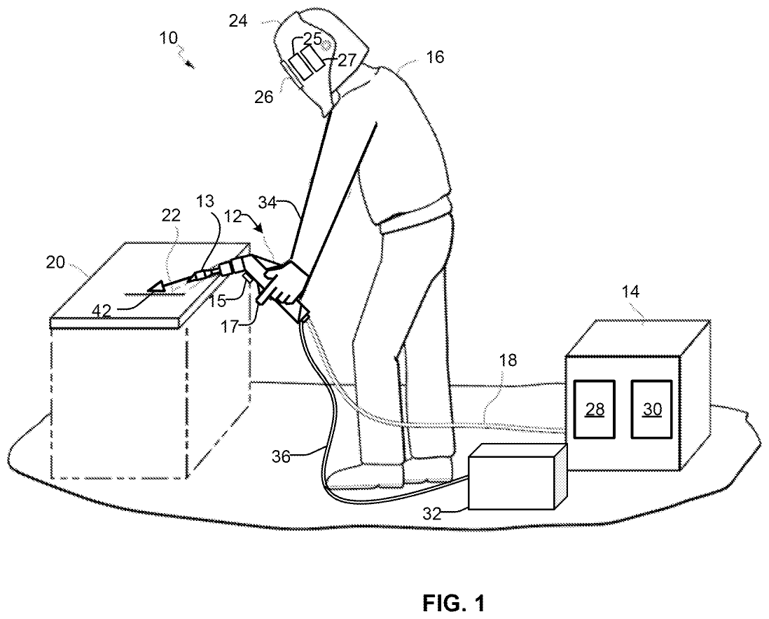

FIG. 1 is a schematic diagram of an example laser welding system 10. The example laser welding system 10 of FIG. 1 includes a laser welding power supply 14, a laser power source 28, a laser controller 30 (e.g., a processing circuitry, control circuitry, memory circuits, interface and/or communication circuitry, etc.), and a wire feeder 32. A handheld laser welding torch 12 is connected to the power supply 14 via power cable 18, and receives wire 36 from the wire feeder 32. In some examples, the handheld laser welding torch 12 includes one or more of a nozzle 13, one or more user input devices 17 (e.g., a trigger, a knob, graphical interface, interlock, etc.), and/or one or more sensors 15 (e.g., an accelerometer, an inertial measurement unit (IMU), a gravimeter, a laser scanner, a wireless transceiver, an ultrasound sensor, a mechanical sensor, temperature sensor, a magnetometer, a gyroscope, an optical sensor, an electrical sensor, etc.).

The laser source 28 generates welding-type laser power to output a laser beam 42 (e.g., directed light energy) based on input power received from the power supply 14. The laser source 28 may be a light emitting a CO₂ laser, Nd:YAG laser, diode-type laser, fiber laser, disk laser or any other type of laser generator. As used herein, welding-type lasing power refers to laser power having wavelength(s) that are suitable for delivering energy to metal for welding, cutting, and/or cladding. Laser cleaning operations (e.g., laser ablation) are also conducted by directing one or more laser beams on the workpiece. For instance, the handheld laser welding torch 12 scans the laser beam across the workpiece to remove unwanted material (e.g., metal particulates, splatter, etc.).

An operator 16 can wear one or more of a wearable 34 (such as a glove, a smartwatch, etc.) and/or a helmet and/or glasses 24 to protect the welder's eyes and skin, for instance. In some examples, the helmet 24 includes a screen 26, which may be configured to automatically dim when exposed to intense light, may be a filter for one or more wavelengths (e.g., ultraviolet, infrared, etc.), and/or may be connected to another part of the system (e.g., controller 30). This allows the screen 26 to present information to the operator 16 to inform the welding process. Helmets and glasses are often used during a welding operation, including set up of the welding station, calibration, and/or to oversee automated (e.g., robotic) welding operations.

The torch 12 focuses the laser power as a beam 42 at a joint, seam or weld 22 on a workpiece 20. The laser power 42 heats the workpiece 20 to generate a puddle during welding operations. The wire feeder 32 feeds the wire 36 (e.g., filler wire, cladding material, metal additive) to the puddle generated by the laser beam 42. The wire 36 melts into the puddle in the weld 22. The wire 36 may be fed from a wire supply, such as a wire reel or wire supply drum, and may be conveyed through a cable or other suitable conduit.

During a welding process, the laser controller 30 controls a focal point of the laser beam to wobble in multiple axes as applied to the workpiece 20. By moving the focal point in multiple directions, the laser can induce one or more beneficial effects in the weld. Examples of such beneficial effects that can be induced in the lateral direction(s) include agitating or stirring of the puddle laterally (including in patterns) to improve filler mixing, creating a heat gradient in the puddle in at least a partially lateral direction to induce movement and improve puddle wetting, and/or controlling the heating and/or cooling rates of the puddle in at least a partially lateral direction by controlling where heat is concentrated. The changing wobble patterns can be configured to adjust power distribution and to change a penetration profile of the laser.

In some examples, movement of the laser beam is controlled such that side-to-side motion is variable, random, and/or has multiple changing directions, angles, and/or lengths. For instance, side-to-side movement of the focal point may promote gap filling, wetting at the toes of a workpiece, penetration profile, etc., and may be set to a high wobble frequency (e.g., greater than 100 wobbles/movements per second). The location, movement, size and/or intensity of the laser beam itself (e.g., spot size, power output) and/or the wobble pattern (e.g., scanning pattern, frequency, etc.) can change the penetration profile and/or weld bead quality. For instance, the focal point and depth for a 3-5 mm spot size may be appropriate for materials at half an inch or thicker, and changes thereof will affect the depth and weld profile, which may be appropriate for different applications.

An additional, possibly independently controlled forward-backward motion at a lower wobble frequency could be used to result in a substantially rippled appearance, similar to a traditional ripple look of tungsten inert gas (TIG) welds, and/or other desirable characteristics.

The laser beam 42 can be controlled in any desired pattern, which may include, but is not limited to, a pattern with one or more straight lines and/or one or more curves. In some embodiments, the desired pattern may include a pause or break in the pattern, such as a time interval in which the focal point does not move. The desired pattern may include a circle, an ellipse, a zigzag, a FIG. 8, a transverse reciprocating line, a crescent, a triangle, a square, a rectangle, a non-linear pattern, an asymmetrical pattern, a pause, or any combination thereof. As may be appreciated, a pattern or a combination of patterns may be used and optimized for particular welds, welding positions, and/or workpiece configurations (e.g., various joints and workpieces that result those joints). The movement of the focal point and the relative movement between the workpiece 20 and the laser torch 12 causes the focal point to trace a superimposed pattern over the workpiece 20. The example pattern may be traced by the laser beam 42 to agitate the puddle.

### Guarding Systems and Methods

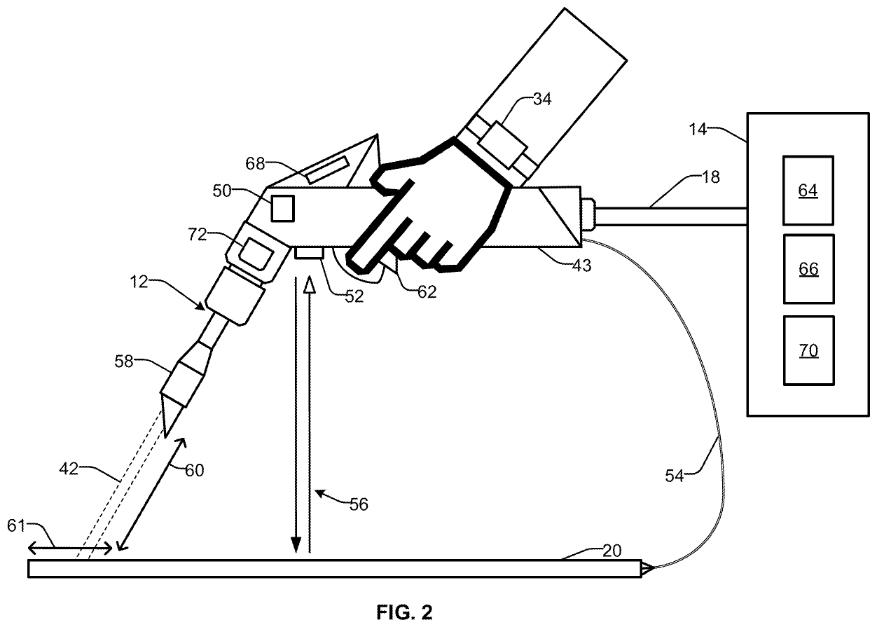

In disclosed examples, systems and methods are employed to ensure laser energy 42 from a laser welding torch 12 is properly positioned prior to engaging in a welding process, as illustrated in FIG. 2.

In examples, a proximity device (50, 52, 34, 64) is employed to measure and/or determine a distance 60 between the laser welding torch 12 and the workpiece 20. The proximity device could include one or more sensors, employing mechanical, optical, ultrasound, electrical, laser, and/or wireless technologies. For instance, the proximity device could measure the distance 60 between a nozzle 58 of the laser welding torch 12 and the workpiece 20, and compare the distance to a list of threshold distances maintained in a memory 70, and/or accessible through a remote database. The list could include multiple thresholds and/or ranges of threshold distances, such that violating one or more of the thresholds could invoke a response from the welding system.

For example, if the measured distance is within a first threshold corresponding to a desired distance (e.g., for a given set of welding parameters), the welding system can activate the laser power source 28 to enable laser welding. If the measured distance is outside the first threshold but within a second, greater threshold, the welding system may generate an alert and/or require an input (e.g., adjustment of one or more welding parameters) from an operator prior to activation of the laser power source. If the measured distance is outside the second threshold, the welding system may disable the laser power source. The operator should move the welding torch to a distance from the workpiece within the first threshold in order to enable welding.

The threshold distances may correspond to a focal plane or focal point 61 for the laser beam 42. The desired distance or various thresholds may change, depending on application, physical parameters associated with the welding process, and/or a selected welding schedule profile. In examples, a focusing optic or lens 72 (e.g., one or more lenses, galvanometers, minors, etc.) can adjust one or more parameters of the laser beam 42 (e.g., location on the workpiece 20, spot size, focal plane, wobble pattern, etc.) in response to sensor and/or user input.

In some examples, the proximity device includes a laser range measurement tool 52 to measure the distance. The laser range measurement tool 52 may be arranged on the laser welding torch (e.g., proximate the nozzle, on the torch neck, on the torch handle 43, etc.), such that the laser range measurement tool 52 is able to measure the distance by transmitting and receiving a signal when the laser welding torch is positioned in preparation of initiating a weld. In some examples, the signal is electromagnetic (e.g., laser light), but could be ultrasound or other such signal.

In some additional or alternative examples, the functions of the measurement laser can be performed by controlling an output of the laser power (e.g., at a low power).

In examples where the laser source is capable of operating as a laser measurement system and a laser welding system, an interlock device (e.g., physical and/or software) can be employed to ensure a desired amount of laser power is delivered for each application. For instance, the interlock could operate by allowing provision of laser power from separate power supplies; in other words, the laser power source can include first laser circuitry (e.g., to deliver a high-powered laser for welding) and second laser circuitry, with the interlock device capable of allowing one or the other from operating and/or providing power to the laser welding torch. In some examples, each application are powered by separate laser sources (e.g., physically and electrically separate).

In some examples, a sequence of measurements and/or actions are needed prior to initiating a weld operation. A first action can activate the laser range measurement tool (e.g., hitting a first button or switch). Once the distance has been confirmed, which may monitor the distance for a given amount of time (e.g., 1-3 seconds), a second switch or the laser welding torch trigger can be enabled to activate the laser power supply. Such instructions can be provided via a user interface 66, which can also receive inputs from the operator. In some examples, the handheld laser welding torch 12 includes a user interface 68 (e.g., a knob, switch, trigger, graphical interface, audio input device, etc.), to provide inputs and/or present information and alerts.

In some examples, the proximity device is a mechanical switch configured to contact the torch and workpiece to determine a distance there between. A work clip 54 of a given length may be used to connect the workpiece and the laser welding torch, which may provide a signal to the welding system that the proximity requirement is satisfied. Although illustrated as connecting the workpiece 20 directly to the handheld laser welding torch 12, in some examples the work clip 54 may connect directly to the power supply 14, which is connected to the torch via cable 18.

In some examples, the sequence includes one or more redundant steps and/or devices to activate the laser power source (and/or the laser welding torch). For instance, a finger or thumb guard 62 may have to be moved or removed, another switch may require activation, and/or a confirmation signal (e.g., via a user interface) should be submitted in order to access the trigger.

During one or more stages of the sequence, the welding system may control one or more welding parameters, such as activation of shielding gas, a wire feeder, and/or power settings, in preparation for commencement of laser welding.

An alert, indicator, and/or signal 50 (e.g., visual, audible, and/or haptic feedback signal) can be used to inform the operator of the status and/or changes in status. For instance, a light (e.g., a LED) may indicate laser power and/or laser welding torch status, thereby informing the operator that the welding torch is active, and a trigger pull will initiate welding.

Upon installation, a work cell could be mapped to identify openings and/or directions that are not desirable for activation and/or application of the laser welding torch. An additional guarding technique could include using directional/vector coordinates corresponding to the orientation and/or direction in which the laser welding torch is pointed. Using triangulation data within a work cell of known the locations and/or directions, the system can determine whether that position and/or orientation of the laser welding torch is pointed in an undesirable direction, and prevent activation in response. This could allow for substantially automated and software-driven guarding methods and/or enclosures. The described work cell and control can be used independently or in conjunction with the methods and systems disclosed herein.

### Personal Protective Equipment and Laser Welding Systems

In disclosed examples, systems, methods, sequences and/or techniques can be employed to ensure equipment and/or operators are prepared for a given welding operation. In examples, components of a laser welding system, laser welding torch, personal protective equipment (PPE), workpiece, and/or other associated systems can include one or more indicators that confirm the interoperability of the components and systems, the suitability of the environment, and/or the training level of the operator.

In some examples, the laser welding system may include a user interface, a reader and/or scanner 64 (e.g., a proximity sensor, a laser scanner, an RFID reader, fingerprint reader, etc.) to read a device 50, 34 (e.g., a near field communication (NFC) tag, a badge, RFID tag, a barcode, wireless radio frequency (RF), Bluetooth (BT) connection, a universal serial bus (USB) device, etc.) on an associated system. Information about the device or associated system can be compared to a list (e.g., stored in the laser welding system and/or in a remote and/or networked computing system). If the comparison indicates the components, devices and/or systems are compatible, the laser welding system may activate and/or unlock one or more system components (e.g., an interlock, a trigger, contactor) and/or welding parameters (e.g., power output, wire feed speed, shielding gas flow rate, etc.) to initiate a welding sequence and/or allow the operator to engage in a welding operation.

In an example sequence, the operator may turn on the system, which provides the operator with a series of prompts corresponding to instructions for preparing the system and/or environment for a laser welding operation. The system may request information about the operator (e.g., credentials, certifications, position within the relevant entity, etc.), information from the operator regarding the welding operation (e.g., the type of material to be welded, type of wire, type of weld being performed, type of gas, type of joint, orientation of the joint, etc.), the type of welding tool being used (e.g., a manually operated laser welding torch), and/or the PPE in use.

The system may have a variety of input devices for collecting information, which may include redundancy to ensure proper compliance with relevant rules and requirements for a particular system, welding operation, and/or environment.

In some examples, the PPE could be suitable for a variety of welding operations, such as when employed by an operator with a particular level of credentials and/or if used in conjunction with other PPE. For instance, a more experienced operator may be able to unlock a more sophisticated welding tool, may be able to calibrate a welding tool and/or welding system, and/or setup a welding station, whereas a less experienced operator may be locked out of some options. Further, some welding operations may require a particular type of helmet (e.g., suited for laser welding, laser and arc welding, and/or arc welding), which should be recognized by the system before a welding operation can commence.

In some examples, a calibration technique can be included in a sequence of events to determine and/or set a given position and/or orientation as a “home” position and/or orientation. This can be done via prompting from the system to confirm the position and/or orientation, and/or automatically as the system recognizes the position and/or orientation at the initial trigger pull and/or activation of the laser welding torch or welding operation. The threshold values can correspond to a given welding operation, material type, join type, joint orientation, and/or other welding parameter. In some examples, the operator can set the thresholds prior to activating the welding torch.

In some examples, once the home position and/or orientation has been set, a lock function can be activated such that changes to the calibration and/or home position and/or orientation are prohibited. This ensures that unintentional and/or unauthorized changes to the position and/or orientation and/or thresholds are not accepted (e.g., after a welding operation commences).

In some examples, the PPE can include an input device to receive an input from the operator and/or component, and can convey the information to the system. For instance, the system and/or the PPE may be able to read information from a wearable device 34 (such as a smartwatch, ring, smartphone, glove, etc.) that contains operator credentials, etc. In some examples, the helmet may include a device 25 (e.g., a retinal scan, a voice recognition feature, etc.) to receive operator credential verification and convey the information to the system.

If the comparison determines that one or more of the desired elements is not present (e.g., the operator credentials do not meet the required level, the type and/or combination of PPE is not suitable, etc.), then the system can lock the system, one or more system components, and/or lock out the operator from activating the system.

In some examples, the PPE, operator and/or components (e.g., the laser welding torch), are equipped with a device 34, 50 to indicate a distance between one another, the system, and/or the workpiece (e.g., NFC communications, an optical scan, a near field communication (NFC) tag, a badge, RFID tag, a barcode, wireless radio frequency (RF), BT connection, a USB device, etc.). Once the distance has been established, the distance can be monitored to ensure the operator and/or components are maintained within a desired threshold distance 60 (based on a comparison with a list of threshold distance values, stored in the system controller 30 or a networked device).

In examples, the laser welding torch sensors 50, 52 may include one or more of an accelerometer, an inertial measurement unit (IMU), a gravimeter, a laser, a wireless transceiver, an ultrasound sensor, and/or a gyroscope, as a list of non-limiting examples. Such sensors can measure a position of the torch 12 to determine whether a position and/or orientation (e.g., angle relative to the workpiece and/or a calibrated/initial orientation) the torch 12 has changed beyond a threshold amount, indicating the torch nozzle 58 has deviated from a welding position or other desirable application. This may indicate an orientation of a downward facing torch has shifted (e.g., by an angle greater than 45 degrees and/or too rapidly) such that the nozzle 58 is oriented laterally and away from the workpiece 20. Some example sensors can measure a position and/or distance 60 of the torch 12 relative to the workpiece 20 by sending a signal and receiving feedback 56.

During a welding operation, sensors 52 can be used to monitor the weld and ensure the parameters of the welding system and/or the characteristics of the weld are maintained within a desired threshold amount. In some examples, sensors 52, 64 in the laser welding system (e.g., at the laser welding torch) and/or sensors 27 arranged on and/or integrated with the helmet are configured to monitor, measure, and/or communicate with the system and various components. For instance, the sensors may monitor light from the laser, heat, plume and/or plasma emissions from the weld. The plume emissions, for example, may have an expected profile, and/or changes in the profile may be monitored. If the profile changes beyond a given threshold amount (including lack of any noticeable profile), the sensor data can indicate that welding conditions have changed or not been established. These changes can be indicators of mis-operation and/or welding defects such as burn through (e.g., the laser has pierced through the workpiece), which may prompt the system to reduce or turn off the laser welding system and/or the laser source.

Additionally, employing multiple sensors provides multiple data sets to increase robustness of the data and raise the confidence of resulting calculations. Further, the helmet may provide a visual of the weld and/or plume on screen 26, providing the operator another indication as to the progress of the welding operation.

In some examples, one or more of the sensors can be and/or operate as a mass spectrometer to analyze the wavelengths of light from the weld. The light data can be used to determine a material and/or alloy(s) of the workpiece(s) and/or filler material. This information can be displayed to the operator (e.g., at the screen 26) and/or used to adjust one or more welding parameter during a welding operation (e.g., dynamically, in real-time, etc.). For some metals it might be desirable to change the wobble for “stirring” innovative materials (e.g., for materials and/or alloys, which can nickel and/or titanium) and/or cladding materials. Such techniques control welding penetration and can mitigate and/or prevent excessive dilution rates of the weld and/or filler material.

In some examples, the helmet is configured for both arc and/or laser welding, providing eye and face protection from both arc emissions and laser intensity. In some examples, the screen 26 to filter ultraviolet light (UV) and near infrared (IR) wavelengths is always on, with an added feature for auto-darkening in response to light from arc emissions.

In some examples, a weld guide device can be employed to provide an indication to the operator as to a direction of the weld. For instance, the weld guide device could be a laser enabled device, projecting a laser spot, a pattern, and/or an image on the workpiece to guide the operator along the weld path (e.g., for a known welding operation). The laser from such a device may have a wavelength in the visible, optical spectrum, and/or be selected to interact with a sensor and/or filter (e.g., at the helmet visor) to present the laser on the workpiece to the operator.

In examples, the weld guide device scans the workpiece during the welding operation and provides updated information to the system. For instance, if a change is upcoming (e.g., an end of the workpiece, a corner, a different type of joint, etc.), the system can automatically change one or more welding parameters and/or present instructions or alerts to the operator. Moreover, employing data from multiple sources (e.g., from stored information regarding a known weld or workpiece and/or sensor data) allows the system to adjust in a more controlled manner, providing enhancements to the weld output.

The system may include capabilities to overlay information onto the operator's view screen 26 (e.g., within the helmet), thereby providing a mediated reality experience for the operator.

In some examples, the system can capture images of the weld puddle by sensor (e.g., camera) to determine if a weld bead has been established. Once established, the system continues to monitor the characteristics (e.g., dimensions of the weld puddle, temperature, etc.) of the weld bead to ensure the characteristics are within a range and/or threshold value corresponding to a quality weld. In some examples, the sensor information is sent to the controller, which compares the measured characteristics to one or more threshold values, and adjusts one or more welding parameters if the measured characteristics violate one or more such thresholds.

In some examples, the view screen can present an image associated with a plasma emission, which indicates the workpiece is being welded. Plasma corresponds to vaporized ionic material released during the welding operation, the EM spectrum is captured by the sensor (e.g. a photodiode, a spectrometer, camera, etc.) and can be presented to the operator and/or to the system controller. For instance, a sensor provides a measure of intensity of the plasma emission, and provides the information to the controller to determine if the welding parameters associated with the plasma emission are within one or more threshold values. Burn through and/or spatter will change the intensity of the plasma emission, which may indicate issues with the laser and/or weld. The system can compare the intensity value and/or rate of change in intensity to a list of threshold values and turn off the laser source if it violates a threshold amount.

In some examples, the view screen can present an image associated with the welding plume, which indicates the workpiece is being welded. The view screen 26 may present an image of the plume and associated dimensions, changes of which may indicate changes in one or more welding parameters. For instance, if the plume shifts from a (relatively) large size to a small size, this may indicate that laser power is not heating the workpiece. The laser power may have been discontinued, suggesting an issue with laser power generation and/or delivery, and/or the welding laser beam is not contacting the workpiece, suggesting the laser has burned through the workpiece.

In some examples, the weld guide device could be employed to scan the workpiece and determine a desired target for shielding gas application (e.g., within a deep crevice, hole, etc.), and guide the torch to apply the gas accordingly.

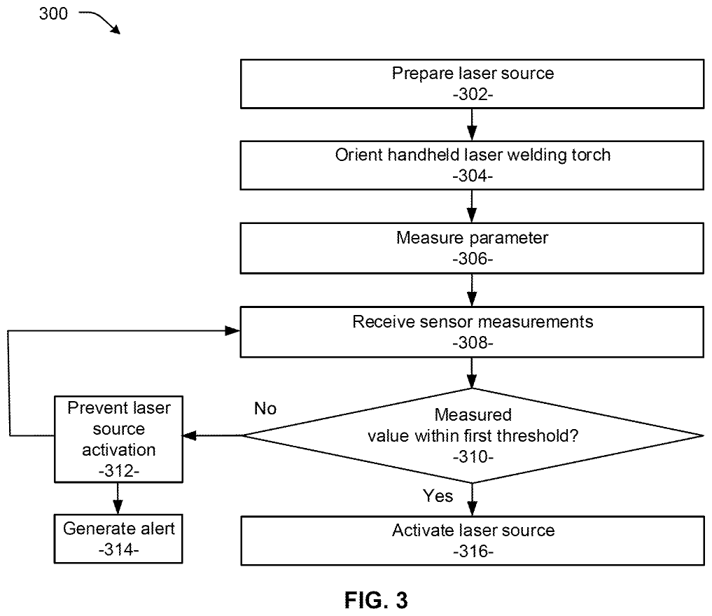

FIG. 3 illustrates an example method 300 being implemented by a laser welding system employing a handheld laser welding torch as provided in FIGS. 1 and 2. In block 302, a laser source is activated to prepare for generation of laser power to perform a welding operation. In block 304, the handheld laser welding torch is oriented to direct the laser power to a workpiece. In block 306, a sensor measures one or more parameters corresponding to a distance from a focusing lens (e.g., to output the laser beam) to a focal plane at or near the workpiece.

For example, the distance may shift up or down and may be non-zero, depending on the application, joint type, or other factors. The focal plane or point would have the laser beam(s) converge at a desired spot to provide the selected spot size and/or intensity for a given weld. In examples, the distance would be specifically selected based on welding profiles, such that different welding operations (e.g., MIG, TIG, plasma, cleaning, etc.) may require different power and/or laser characteristics.

The sensor includes one or more of an accelerometer, an inertial measurement unit (IMU), a gravimeter, a laser sensor, a wireless transceiver, an ultrasound sensor, a mechanical sensor, temperature sensor, a magnetometer, a gyroscope, an optical sensor, or an electrical sensor.

In block 308, a laser controller receives the sensor measurements of the one or more parameters to determine the distance. In block 310, the laser controller compares the distance to a list of threshold distances. Based on the comparison, the laser controller is further to control the laser source or the handheld laser welding torch in accordance with the determined distance.

For example, if the distance exceeds a first threshold distance (e.g., distance 60 of FIG. 2), in block 312 the laser controller prevents the laser source from generating the laser power, and can return to block 308. For instance, preventing the laser source from generating the laser power may include disabling the laser source, disconnecting a power source from the laser source, or activating an interlock. In response, the laser controller generates a first alert or require a first input from a user if the distance exceeds the first threshold distance in block 314.

If the distance is within the first threshold distance, the laser controller enables the laser source to generate the laser power in block 316.

In some examples, the laser controller generates an alert or requires a second input from a user if the distance exceeds the first threshold distance.

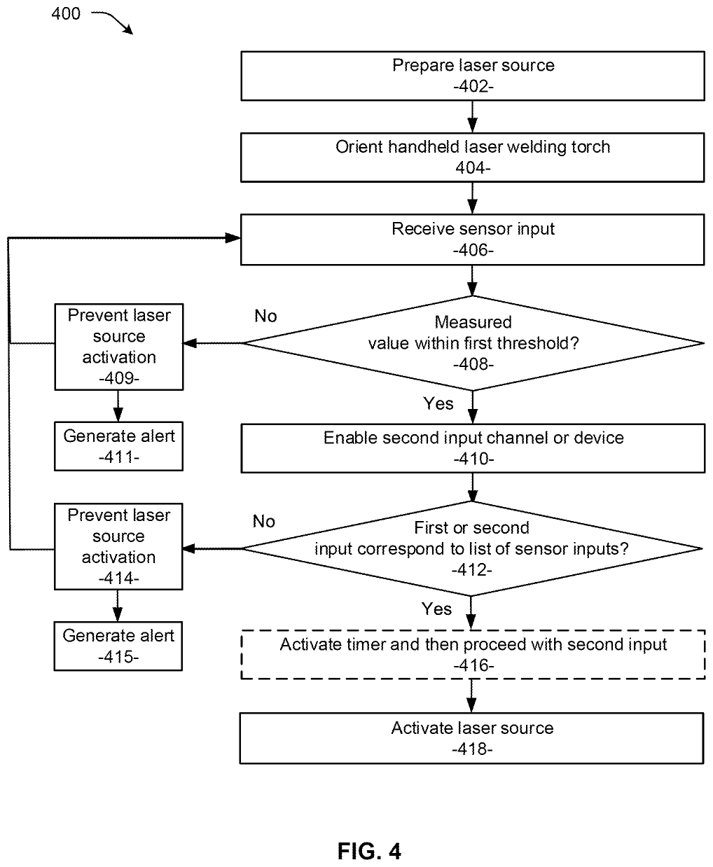

FIG. 4 illustrates another example method 400 being implemented by a laser welding system employing a handheld laser welding torch as provided in FIGS. 1 and 2. In block 402, a laser source is activated to generate laser power to perform a welding operation. In block 404, the handheld laser welding torch is oriented to direct the laser power to a workpiece.

In block 406, a laser controller receives a first sensor input from a sensor associated with the laser welding system. In response to receipt of the first sensor input meeting one or more conditions in block 408 (e.g., comparison to a list of acceptable values, passing a predetermined power threshold, receipt of a code, one or more desired signal characteristics present, etc.), the laser controller enables a second input channel or device in block 410. If the first sensor input fails to meet the desired one or more conditions, the method proceeds to block 409 to prevent the laser source from generating the laser power. In response, the method returns to block 406, and the laser controller generates a first alert in block 411.

Upon receipt of a second input from a user, sensor, and/or another system (e.g., remote computer, personal electronic device, wearable, etc.), the laser controller compares the first or second input to a list of sensor inputs associated with operation of the laser welding system in block 412, and determines whether the first input corresponds to a sensor input of the list of sensor inputs associated with one or more predetermined operational parameters. If the first input does not correspond to the sensor input, in block 414 the laser controller prevents the second input (e.g., prevents activation of the second input device, prevents execution of commands from the second input, etc.), returns to block 406, and the laser controller generates a second alert in block 415.

In some examples, the laser controller requires a third input (e.g., sensor input, user input, response to a challenge, etc.) to either enable the second input or to activate the laser power generator. The third input can include removal of a finger or thumb guard, activation of a switch, and/or selection of a user interface.

In some optional examples, if the first input does correspond to the sensor input, the laser controller activates a timer in block 416. Once a predetermined time has lapsed, the laser controller then compares the second input to the list of items and control the system accordingly.

Upon confirmation that the second input has been received and meets the required criteria, in block 418 the laser controller commands the laser source to generate the laser power. This can include control of one or more welding parameters, which can be adjusted and/or selectively activated based on the comparisons of the first and second inputs. Thus, the welding parameters include laser power settings, shielding gas flow, and/or wire feeder speed.

Typically, the laser controller enables access to a trigger of the handheld laser welding torch in response to the confirmation signal, which then allows the user to control the welding process.

In disclosed examples, a laser source to generate laser power to perform a welding operation includes a handheld laser welding torch to direct the laser power to a workpiece; and a sensor to measure one or more parameters corresponding to a distance (e.g., greater than zero) from a focusing lens to a focal plane (e.g., up or down) at or near the workpiece (e.g., different power for different welding cleaning).

In some examples, the sensor includes one or more of an accelerometer, an inertial measurement unit (IMU), a gravimeter, a laser sensor, a wireless transceiver, an ultrasound sensor, a mechanical sensor, temperature sensor, a magnetometer, a gyroscope, an optical sensor, or an electrical sensor.

In some examples, a second sensor includes one or more of an accelerometer, an inertial measurement unit (IMU), a gravimeter, a wireless transceiver, temperature sensor, a magnetometer, or a gyroscope. The second sensor may provide yet another sensor input which may inform one or more welding parameters and/or be required to enable and/or disable the handheld laser welding torch activation.

In some examples, the laser welding system further includes a laser controller to receive measurements of the one or more parameters from the sensor to determine the distance.

In examples, the laser controller is further to compare the distance to a threshold distance and/or a list of threshold distances (e.g., corresponding to different weld schedules, welding operations, etc.). For example, particular threshold distances can be input by a user for a give welding operation (e.g., based on joint type, material type, workpiece arrangement, etc.).

In examples, the laser controller is further to control the laser source or the handheld laser welding torch based on the distance.

In some examples, the laser controller is further to prevent the laser source from generating the laser power if the distance exceeds the threshold distance (e.g., among the list of the threshold distances).

In examples, the laser controller is further to enable the laser source to generate the laser power if the distance is within the threshold distance.

In some examples, disable the laser source output and generate a first alert or require a first input from a user if the distance exceeds the threshold distance.

In some examples, preventing the laser source from generating the laser power includes disabling the laser source, disconnecting a power source from the laser source, or activating an interlock.

In some disclosed examples, a laser welding system includes a laser source to generate laser power to perform a welding operation; a handheld laser welding torch to direct the laser power to a workpiece. A laser controller is configured to receive a first input from a sensor associated with the laser welding system; enable a second input channel or device based on the first input; receive a second input from a user. In examples, the laser controller further controls the laser source to generate the laser power based on the comparisons.

In some examples, the laser controller is further configured to compare the first input to a list of sensor inputs associated with operation of the laser welding system; determine whether the first input corresponds to a sensor input of the list of sensor inputs associated with one or more predetermined operational parameters; compare the second input to the list of items if the first input corresponds to the sensor input; and prevent the second input if the first input does not correspond to the sensor input.

In some examples, the laser controller is further configured to activate a timer following the determination that the first input corresponds to the sensor input; and disable the second input channel or device after a predetermined time has lapsed (e.g., from the timer).

In some examples, the laser controller is further configured to activate a timer following the determination that the first input corresponds to the sensor input; and enable the second input channel or device within a predetermined time has lapsed.

In some examples, the second input is a trigger of the handheld laser welding torch.

In some examples, the laser controller is further configured to control one or more welding parameters based on the first and second inputs, the one or more welding parameters including laser power settings, shielding gas flow, or wire feeder speed.

In some disclosed examples, a laser welding system includes a laser source to generate laser power to perform a welding operation; a handheld laser welding torch to direct the laser power to a workpiece; a protective item arranged to be worn by a user; one or more devices arranged on the handheld laser welding torch, or the protective item; and a laser controller to receive information from the one or more devices prior to activation of the laser source or the handheld laser welding torch.

In some examples, the one or more devices include a near field communication (NFC) tag, a badge with optically scripted information, a radio frequency identification (RFID) tag, a barcode, a wireless radio frequency (RF) tag, and a Bluetooth (BT) enabled tag.

In some examples, the protective item includes one or more of a helmet, glasses, goggles, gloves, a jacket, a watch, a badge, or radio frequency identification (RFID) tag.

In some examples, a device reader (e.g., on the laser source or other component of the welding system) to read the one or more devices.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A laser welding system, comprising:
a laser source to generate laser power to perform a welding operation;
a handheld laser welding torch to direct the laser power to a workpiece; and
a sensor to measure one or more parameters corresponding to a distance from a focusing lens to a focal plane at or near the workpiece.

2. The laser welding system of claim 1, wherein the sensor includes one or more of a laser sensor, an ultrasound sensor, a mechanical sensor, an optical sensor, or an electrical sensor.

3. The laser welding system of claim 1, further comprising a second sensor includes one or more of an accelerometer, an inertial measurement unit (IMU), a gravimeter, a wireless transceiver, temperature sensor, a magnetometer, or a gyroscope.

4. The laser welding system of claim 1, further comprising a laser controller to receive measurements of the one or more parameters from the sensor to determine the distance.

5. The laser welding system of claim 4, wherein the laser controller is further to compare the distance to a threshold distance.

6. The laser welding system of claim 4, wherein the laser controller is further to control the laser source or the handheld laser welding torch based on the distance.

7. The laser welding system of claim 1, wherein the laser controller is further configured to prevent the laser source from generating the laser power if the distance exceeds the threshold distance.

8. The laser welding system of claim 7, wherein the laser controller is further to enable the laser source to generate the laser power if the distance is within the threshold distance.

9. The laser welding system of claim 1, wherein the laser controller is further configured to disable the laser source output and generate a first alert or require a first input from a user if the distance exceeds the threshold distance.

10. The laser welding system of claim 6, wherein preventing the laser source from generating the laser power includes disabling the laser source, disconnecting a power source from the laser source, or activating an interlock.

11. A laser welding system, comprising:
a laser source to generate laser power to perform a welding operation;
a handheld laser welding torch to direct the laser power to a workpiece; and
a laser controller to:
receive a first input from a sensor associated with the laser welding system;
enable a second input channel or device based on the first input;
receive a second input from a user; and
activate the laser welding system in response to the second input.

12. The laser welding system of claim 11, wherein the laser controller is further configured to:
compare the first input to a list of sensor inputs associated with operation of the laser welding system;
determine whether the first input corresponds to a sensor input of the list of sensor inputs associated with one or more predetermined operational parameters;
and
prevent the second input if the first input does not correspond to the sensor input.

13. The laser welding system of claim 12, wherein the laser controller is further configured to:
activate a timer following the determination that the first input corresponds to the sensor input; and
disable the second input channel or device after a predetermined time has lapsed.

14. The laser welding system of claim 12, wherein the laser controller is further configured to:
activate a timer following the determination that the first input corresponds to the sensor input; and
enable the second input channel or device within a predetermined time has lapsed.

15. The laser welding system of claim 12, wherein the second input is a trigger of the handheld laser welding torch.

16. The laser welding system of claim 12, wherein the laser controller is further configured to control one or more welding parameters based on the first and second inputs, the one or more welding parameters including laser power settings, shielding gas flow, or wire feeder speed.

17. A laser welding system, comprising:
a laser source to generate laser power to perform a welding operation;
a handheld laser welding torch to direct the laser power to a workpiece;
a protective item arranged to be worn by a user;
one or more devices arranged on the handheld laser welding torch, or the protective item; and
a laser controller to receive information from the one or more devices prior to activation of the laser source or the handheld laser welding torch.

18. The laser welding system of claim 17, wherein the one or more devices include a near field communication (NFC) tag, a badge with optically scripted information, a radio frequency identification (RFID) tag, a barcode, a wireless radio frequency (RF) tag, and a Bluetooth (BT) enabled tag.

19. The laser welding system of claim 17, wherein the protective item comprises one or more of a helmet, glasses, goggles, gloves, a jacket, a watch, a badge, or radio frequency identification (RFID) tag.

20. The laser welding system of claim 17, further comprising a device reader to read the one or more devices.
